(19) United States
(12) Patent Application Publication
(10) Pub. No.: US 2006/0118675 A1
(43) Pub. Date: Jun. 8, 2006

(54) Transformable fluid foil with pivoting spars and ribs

(76) Inventor: John Zebulon Tidwell, Long Beach, CA (US)

Correspondence Address: c/o Gerald Andersen, 2780 Skypark Drive, Ste 400, Torrance, CA, 90505, US

(21) Appl. No.: 11/007,149

(22) Filed: Dec. 7, 2004

(51) Int. Cl. B64C 1/00

(52) U.S. Cl. 244/123.1

(57) ABSTRACT

An adjustable fluid foil. The fluid foil includes one or more adjustable spars that are connected to one or more adjustable ribs. A deformable surface substantially houses the one or more adjustable spars and ribs. In a specific embodiment, the deformable surface is sufficient to enable changes in one or more span-wise fluid foil geometries in response to adjusting of the frame. In the specific embodiment, the one or more adjustable spars and ribs are substantially coplanar, sharing a plane that is approximately parallel to a surface area of the fluid foil. The one or more adjustable spars and ribs include a mechanism for adjusting the position and/or a mechanism for adjusting the size of one or more adjustable spars and ribs. In one embodiment, the one or more adjustable spars and ribs are pivotally interconnected to facilitate adjustments in relative angles formed therebetween. In this embodiment, the one or more adjustable ribs are connected to the one or more adjustable spars so that actuation of a first spar changes a sweep angle of the fluid foil and simultaneously adjusts a base chord thereof.

This invention was made with Government support under Defense Advanced Research Projects Agency (DARPA) Contract No. F33615-02-C-3257. The Government may have certain rights in this invention.

### BACKGROUND OF THE INVENTION

1. Field of Invention

This invention relates to fluid foils. Specifically, the present invention relates to adjustable fluid foils, such as morphing-aircraft airfoils.

2. Description of the Related Art

Fluid foils are employed in various demanding applications including aircraft wings and propellers, helicopter blades, boat sails and rudders, spacecraft solar sails, swim fins, and various fans. Such applications often demand versatile fluid foils that perform well under various operating conditions.

Versatile fluid foils are particularly important in applications where operating conditions vary widely, such as aircraft applications. A conventional aircraft wing includes a rigid structure shaped to create a desired pressure differential and corresponding lift. Wing shape affects aircraft performance, including speed, maneuverability, takeoff and landing distances, range, loiter time, and altitude capabilities.

Conventionally, fixed wing aircraft employ wing flaps to selectively change overall wing lift and drag properties to meet changing operating conditions. For example, when landing, flaps are often deployed to maintain lift at a slower velocity. During cruising flight, flaps are often retracted to facilitate rapid flight. Unfortunately, limited flap configurations and sizes limit wing controllability and performance capabilities. Consequently, conventional fixed wing aircraft often cannot optimally adapt to extreme flight conditions.

Alternatively, morphing wings are employed. An exemplary morphing wing is disclosed in U.S. Pat. No. 6,622,974, entitled GEOMETRIC MORPHING WING WITH EXPANDABLE SPARS, by Dockter et al., issued Sep. 23, 2003, and assigned to The Boeing Company. The morphing wing employs an inflatable spar positioned within the wing. Inflating or deflating the spar causes changes in wing camber. Unfortunately, the morphing wing has relatively limited ability to drastically change important wing characteristics, such as wing sweep. Furthermore, additional safeguards may be required to prevent bladder leaking and to provide sufficient wing rigidity, which may complicate the design and increase costs.

An alternative morphing wing is disclosed in U.S. Pat. No. 5,899,410, entitled AERODYNAMIC BODY HAVING COPLANAR JOINED WINGS, by Timothy M. Garrett, issued May 1, 1999 and assigned to McDonnell Douglas Corporation. This morphing wing enables wing sweep adjustments but lacks substantial wing area adjustment capability. Furthermore, the wings are mechanically linked so that actuation of one wing causes actuation of the other. Hence, wings on one side of the aircraft must maintain similar configurations as corresponding wings on the opposite side of the aircraft. This limits overall aircraft controllability. Furthermore, the accompanying aircraft requires at least four wings, including a forward wing and an aft wing on each side of the aircraft. These additional wings and accompanying edges may complicate flight characteristics and increase aircraft design and implementation costs.

Another morphing aircraft wing is disclosed in U.S. Pat. No. 5,671,899, entitled AIRBORNE VEHICLE WITH WING EXTENSION AND ROLL CONTROL, by Nicholas, et al. and assigned to Lockheed Martin Corporation. This morphing aircraft wing may enable changes in wing sweep. However, it does not enable substantial changes in wing area, which limits controllability of flight characteristics.

An alternative telescoping wing is disclosed in U.S. Pat. No. 4,824,053, entitled TELESCOPING WING, by Branko Sarh. The wing employs a flexible or sliding skin structure that covers telescoping spars. The telescoping spars include rotatable and non-rotatable overlapping spar sections. Unfortunately, such use of interconnected alternating rotatable and non-rotatable spars necessitates complex mechanisms to stabilize the fixed sections relative to the rotatable sections and to rotate the rotatable sections. Implementation may require undesirably bulky ring gears, motors, worm gears, and toothed belts. Furthermore, if one spar becomes jammed, the remaining spars may also jam, or the motors driving the other spars may cause uneven spar extension, thereby destroying the wing.

Another morphing aircraft wing is disclosed in U.S. Pat. No. 6,045,096, entitled VARIABLE CAMBER AIRFOIL, by Rinn, et al. This airfoil incorporates a flexible skin and a movable internal structure to enable changes in airfoil camber. Unfortunately, this airfoil does not facilitate airfoil sweep adjustments or substantial changes in airfoil area.

Morphing aircraft wings also include variable-sweep wings, which are currently employed in certain military aircraft to improve the critical Mach number and reduce high-speed drag to facilitate supersonic flight. An exemplary variable-sweep wing is disclosed in U.S. Pat. No. 6,073,882, entitled FLYING VEHICLE WITH RETRACTABLE WING ASSEMBLY, issued June 13, 2000. The retractable wing assembly employs pivoting nesting wing vanes or fins that are supported by a vane support member. The vane support member may be repositioned via an articulating assembly to fold and unfold the wing assembly. Unfortunately, the wing assembly requires potentially problematic links between vanes, and the links may restrict the vanes to certain positions. Furthermore, the large numbers of interconnected links and levers may be complex to implement and undesirably prone to fatigue. In addition, the wing assembly enables relatively limited adjustments in various wing characteristics.

Various additional variable-sweep wings are disclosed in U.S. Pat. No. 1,215,295 (Issued Feb. 6, 1917), U.S. Pat. No. 2,744,698 (Issued May 8, 1956), U.S. Pat. No. 3,064,928 (Issued Nov. 20, 1962), U.S. Pat. No. 3,092,355 (Issued Jun. 4, 1963), U.S. Pat. No. 3,330,501 (Issued Jul. 11, 1967), U.S. Pat. No. 3,481,562 (Issued Dec. 2, 1969), U.S. Pat. No. 3,654,729 (Issued Apr. 11, 1972), U.S. Pat. No. 3,738,595 (Issued Jun. 12, 1973), U.S. Pat. No. 3,662,974 (Issued May 16, 1972), U.S. Pat. No. 3,738,595 (Issued Jun. 12, 1973), U.S. Pat. No. 3,971,535 (Issued Jul. 27, 1976), and U.S. Pat. No. 5,992,796 (Issued Nov. 30, 1999). Generally, these U.S. patents describe folding wings or wings having sections that fold into themselves or into slots in an accompanying aircraft fuselage. Unfortunately, these variable-sweep wings, which are often adapted for supersonic flight, typically cannot efficiently or independently adjust various wing characteristics, such as wing shape and area. Consequently, they often exhibit limited performance at low speeds and may require additional special control surfaces, such as flaps and ailerons, to facilitate flight maneuvers.

Accordingly, conventional morphing wings often provide relatively limited configurations and are often relatively complex or expensive to implement.

Hence, a need exists in the art for an efficient, configurable, and cost-effective fluid foil that may efficiently adjust to accommodate various operating conditions.

### SUMMARY OF THE INVENTION

The need in the art is addressed by the adjustable fluid foil of the present invention. In the illustrative embodiment, the inventive fluid foil is adapted for use as an aircraft airfoil. The fluid foil includes a frame that comprises one or more adjustable spars that are connected to one or more adjustable ribs. A deformable surface substantially houses the one or more adjustable spars and ribs.

In a specific embodiment, the deformable surface is sufficient to enable changes in one or more span-wise fluid foil geometries in response to adjusting of the frame. In this embodiment, the one or more adjustable spars and ribs are substantially coplanar, sharing a plane that is approximately parallel to a surface area of the fluid foil. The one or more adjustable spars and ribs include a mechanism for adjusting the position and/or a mechanism for adjusting the size of one or more adjustable spars and ribs. In one embodiment, the one or more adjustable spars and ribs are folding or telescoping.

In a more specific embodiment, the one or more adjustable spars and ribs are pivotally interconnected to facilitate adjustments in relative angles formed therebetween. The one or more adjustable ribs are connected to the one or more adjustable spars so that actuation of a first spar changes a sweep angle of the fluid foil and simultaneously adjusts a chord thereof.

The novel design of one embodiment of the present invention is facilitated by the use of adjustable spars and ribs to form a frame, which is covered by a flexible skin. Airfoil sweep, span, chord, area, and aspect ratio are efficiently adjusted by simply changing angles between the spars and ribs via an actuation system. Use of telescoping or folding spars or ribs further allows independent adjustments of airfoil sweep angle, chord, and span. Furthermore, enabling efficient airfoil span adjustments may greatly facilitate aircraft storage and transport.

### BRIEF DESCRIPTION OF THE DRAWINGS

FIG. 1 is an isometric view of an aircraft employing adjustable airfoils in a first configuration according to an embodiment of the present invention.

FIG. 2 is an isometric view of the aircraft of FIG. 1 showing the adjustable airfoils in a second configuration.

FIG. 3 is a top schematic view of the aircraft of FIG. 1 illustrating a system incorporating spars and ribs for selectively morphing the adjustable airfoils.

FIG. 4 is a top schematic view of the aircraft of FIG. 1 illustrating an exemplary airfoil configuration for implementing asymmetric control capability.

FIG. 5 is a more detailed exploded view of the airfoil of FIG. 3.

FIG. 6 is a top schematic view of an alternative embodiment of an adjustable airfoil that incorporates telescoping ribs and spars.

### DESCRIPTION OF THE INVENTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

For the purposes of the present discussion, a fluid is any substance, gas, or beam of particles that flows or deforms continuously, such as in response to application of a predetermined force, such as a shearing stress. A shearing stress occurs whenever a force acts tangential to a surface. Accordingly, air, water, and solar plasma are all considered fluids.

A fluid foil is any surface designed to manipulate fluid flow. Fluid foils include boat motor propellers, boat sails, solar sails for spacecraft applications, cement mixer blades, and airfoils, such as missile-steering fins and aircraft wings. An airfoil is a fluid foil that is adapted to manipulate air flow.

A deformable skin is a covering with an outer shape and/or surface area that may adapt to accommodate geometrical changes in a structure that supports and/or is covered by the skin. Consequently, sliding skins, and various flexible skins, such as elastomeric skins, are considered deformable skins.

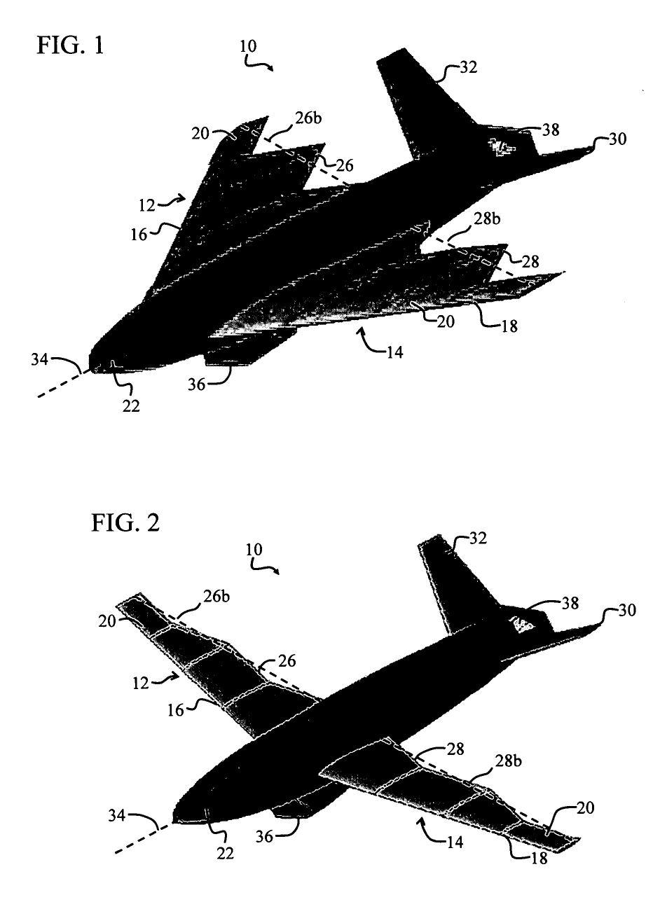

FIG. 1 is an isometric view of an aircraft 10 employing a right transformable airfoil 12 and a left transformable airfoil 14 in a first configuration according to an embodiment of the present invention. For clarity, various features, such as power supplies, antennas, and propulsion systems, have been omitted from the figures. However, those skilled in the art with access to the present teachings will know which components and features to implement and how to implement them to meet the needs of a given application.

In the configuration of FIG. 1, the airfoils 12, 14 are swept back approximately 60° so that respective leading edges 16,18 of the airfoils 12, 14 form an angle of approximately 40° relative to a longitudinal axis 34 of the aircraft 10. For comparison purposes, the present configuration yields airfoil aspect ratios of approximately 1.7, wing areas of 50 square units, semi-spans of 4.65 units, and root chords of approximately 10.4 units.

The airfoils 12, 14 are covered with a flexible skin 20 that stretches to accommodate changes in airfoil shape. The flexible skin 20 may be implemented via an elastomeric material or via a sliding or telescoping skin, which may be constructed from rigid sheets. Suitable flexible skins are discussed more thoroughly in co-pending U.S. patent application Ser. No. ______, entitled TRANSFORMABLE SKIN, the teachings of which are herein incorporated by reference.

For the purposes of the present discussion, a spar is a support beam that is oriented to provide support for an airfoil structure along a line parallel to a leading edge of the fluid foil or a leading edge of a frame of the fluid foil. A rib of a fluid foil is a support beam that is oriented to provide support for the fluid foil along a line that is angled relative to the leading edge of the fluid foil or relative to the leading edge of a frame of the fluid foil.

As discussed more fully below, the airfoils 12, 14 have an internal frame structure that includes adjustable spars and adjustable ribs that are interconnected via pivot connectors. Actuators control relative angles between the spars and ribs to control the shapes of the airfoils 12, 14. The actuators are responsive to control signals from a controller. The spars and ribs are interconnected so that as the chords of the airfoils 12, 14 expand or contract, the leading edges 16, 18 sweep back or sweep forward, respectively.

The airfoils 12, 14 are mounted to an aircraft fuselage 22 via slots having tracks therein, which are discussed more fully below. As the chords of the airfoils 12, 14 expand and contract, the corresponding leading edges 16, 18 and respective trailing edges 26, 28 at the bases of the airfoils 12, 14 slide back and forth within the slots and along the tracks. The trailing edges 26, 28 are shown as jagged, however the trailing edges may be another shape, such as substantially straight without departing from the scope of the present invention. Note that the sweep angle of the reference right trailing edge 26b and the sweep angle of the reference left trailing edge 28b remain fixed while the sweep angles of the leading edges 16, 18 change. Hence, the deformable wings 12, 14 enable independent control of the sweep angle of the leading edges 16, 18 relative to the sweep angles of the trailing edges 28, 26. This may reduce flight-control complexity.

In the present embodiment, the airfoils 12, 14 are rigidly interconnected via a support beam as discussed more fully below. The unique interconnection system preserves the ability of the aircraft 10 to independently change the shapes of the airfoils 12, 14. The aircraft 10 also includes a left tail fin 30 and a right tail fin 32, which may be implemented via adjustable airfoils similar to the airfoils 12, 14.

The aircraft 10 includes an air scoop 36 and a corresponding exhaust 38 for a jet engine (not shown) positioned within the fuselage 22. Positioning the engine within the fuselage rather than mounting the engine on the airfoils 12, 14 may facilitate airfoil operation. However, one or more jet engines may be mounted on the airfoils 12, 14 without departing from the scope of the present invention.

In operation, various characteristics of the airfoils 12, 14, including span, chord, area, sweep angle, and aspect ratio are adjusted by activating internal actuators via a controller, as discussed more fully below, to selectively alter the shapes of the airfoils 12, 14. Airfoil characteristics are adjusted to optimize performance for a given flight operation.

For example, in high-speed flight, the airfoils 12, 14 may be positioned in a swept-back configuration. In low-speed flight, the airfoils 12, 14 may have a reduced sweep angle. Furthermore, the airfoils 12, 14 are independently controllable. Accordingly, performance characteristics of the left airfoil 14 relative the right airfoil 12 may be selectively independently altered to facilitate a particular flight maneuver.

FIG. 2 is an isometric view of the aircraft 10 of FIG. 1 showing the adjustable airfoils 12, 14 in a second configuration. The airfoils 12, 14 are swept back approximately 15°, providing an aspect ratio of approximately 11.3; and for comparison purposes, an area of 29 square units; a semi-span of 9 units; and root chords of approximately 3.1 units.

In the present specific embodiment, a pivot point near the center of the root chord of each of the airfoils 12, 14 remains fixed relative to the fuselage 22 as the airfoils 12, 14 transform, as discussed more fully below. As the sweep angle decreases, the trailing edges 26, 28 and the leading edges 16, 18 come closer together, thereby reducing the airfoil chord lengths, i.e., the distances between the trailing edges 26, 28 and the leading edges 16, 18. Similarly, as the sweep angle increases, the trailing edges 26, 28 and leading edges 16, 18 separate, thereby expanding the chord lengths.

In an alternative embodiment, a pivot point near each of the leading edges 16, 18 of the root chord remains fixed relative to the fuselage 22, and the trailing edges 26, 28 move forward or aft along the fuselage 22 as the sweep angle decreases or increases, respectively. In yet another alternative embodiment, a pivot point near each of the trailing edges 26, 28 of the root chord remains fixed relative to the fuselage 22, and the leading edges 16, 18 move forward or aft along the fuselage 22 within slots along the fuselage 22 as the sweep angle increases or decreases, respectively. In yet another alternative embodiment, the portions of the airfoils 12, 14 that remain fixed relative to the fuselage during a given airfoil-morphing operation are adjustable via controllable locks and tracks. These various alternative embodiments are discussed more fully below.

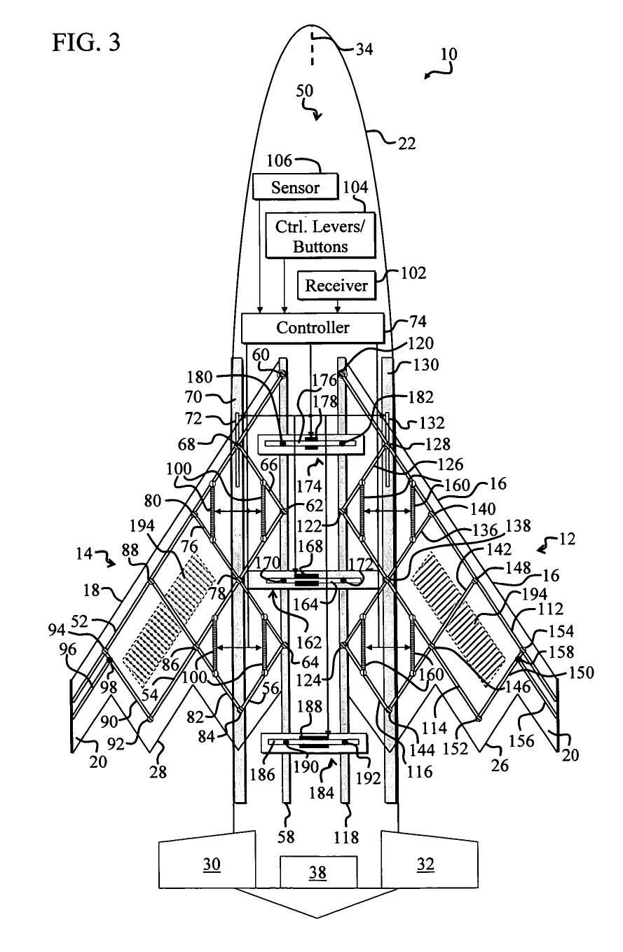

FIG. 3 is a top schematic view of the aircraft 10 of FIG. 1 illustrating a system 50 incorporating spars and ribs for selectively morphing the adjustable airfoils 12, 14. The airfoils 12, 14 are swept back approximately 60° in a similar configuration in as in FIG. 1.

The left airfoil 14 includes a first leading-edge spar 52 that extends along the entire length of the leading left leading edge 18. A second spar 54 is positioned aft of and approximately parallel to the first spar 52. A third spar 56 is positioned aft of and approximately parallel to the second spar 54. The inboard end of the first spar 52 is mounted to a movable left vertical support beam 58 at a first pivot connector 60 that is free to slide within the support beam 58. The inboard end of the second spar 54 is mounted to the left vertical support beam 58 at a second pivot connector 62 that is free to slide within the support beam 58. The inboard end of the third spar 56 is mounted to the left vertical support beam 58 at a third pivot connector 64 that is free to slide within the support beam 58. The support beam 58 acts as a support track that allows the various pivot connectors 60, 62, 64 to slide therein.

A first rib 66 is pivotally connected at one end to the second pivot connector 62 on the left support beam 58 and is pivotally connected at another end to the first spar 52 at a fourth pivot connector 68. The fourth pivot connector 68 is positioned in a left support track 70, and is equipped with a left track break 72 that is responsive to control signals from a controller 74. The fourth pivot connector 68 may slide within the left support track 70 as the first spar 52 is swept forward or aft when the position of the pivot connector 68 is not locked in the left support track 70 via the left track lock 72.

A second rib 76 extends from the third pivot connector 64 and is connected to the second spar 54 at a fifth pivot connector 78 and to the first spar 52 at a sixth pivot connector 80. In the present specific embodiment, the fifth pivot connector 78 remains locked within the left support track 70 and does not translate therein.

The third spar 56, which is connected at one end to the third pivot connector 64, is connected at an opposite end to a third rib 82 at a seventh pivot connector 84. The seventh pivot connector 84 is positioned within the left track 70 and is free to slide within the left track 70 when the left track lock 72 is unlocked.

The third rib 82 extends from the seventh pivot connector 84 and is connected to the second spar 54 at an eighth pivot connector 86 at the approximate center of the third rib 82. A terminal end of the third rib 82 is connected to the first spar 52 at a ninth pivot connector 88.

A fourth rib 90 is connected between the second spar 54 and the first spar 52 at a tenth pivot connector 92 and an eleventh pivot connector 94, respectively. A fourth support spar 96 is mounted to the fourth rib 90 at a first fixed connector 98.

In the present embodiment, the ribs 66, 76, 82, and 90 and the spars 54-56 are approximately coplanar and together form an adjustable frame. The plane containing the ribs 66, 76, 82, and 90 and the spars 54-56 is approximately parallel to or is slightly angled relative to the surface formed by the flexible skin 20.

The left airfoil 14 includes left actuators 100 that receive control input from the controller 74. The controller 74 receives input from a receiver 102, control levers/buttons 104, and a sensor suit 106.

The airfoils 12, 14 are further equipped with bellows structures 194 to control airfoil torsion. The bellows structures 194 may be mounted at opposite ends to airfoil ribs or other structures. Exact mounting systems and methods for the bellows structures 194 are application-specific and may be determined by those skilled in the art to meet the needs of a given application without undue experimentation. Suitable airfoil bellows structures are discussed more fully in co-pending U.S. patent application Ser. No. ______, entitled DEFORMATION-CONTROL SYSTEM AND METHOD, which is incorporated by reference herein.

Those skilled in the art will appreciate that materials selection is application-specific and may be determined by those skilled in the art to meet the needs of a given application without undue experimentation. The appropriate material for various airfoil components, such as the frame (comprising ribs 66, 76, 82, and 90 and the spars 54-56) and the deformable skin 20 may be readily determined by those skilled in the art to meet the needs of a given application. For example, a miniature Unmanned Aerial Vehicle (UAV) that experiences minimal aerodynamic loads may employ a different deformable skin than a fighter jet, which may require a substantially stronger skin.

The right airfoil 12 is similar to the left airfoil 14 and includes components 112-160 that correspond directly to the components 52-100 of the left airfoil 14. A central horizontal support beam 162 extends from the left fifth pivot connector 78 in the left support track 70 to the corresponding right fifth pivot connector 138 in the right support track 130. The central horizontal support beam 162 is fixed relative to the fuselage 22. Accordingly, the pivot connectors 78, 138 are fixed within the respective support tracks 70, 130.

The central horizontal support beam 162 includes a first horizontal slot 164 that is equipped with a first slot break 168. The first horizontal slot 164 accommodates a first left peg 170 and a first right peg 172 that are rigidly connected to the left vertical support beam 58 and a corresponding right vertical support beam 118, respectively. The first slot break 168 is responsive to control signals from the controller 74 and selectively releases the vertical support beams 58, 118 to accommodate airfoil morphing operations and locks the beams 58, 118 to secure a desired airfoil configuration.

The system 50 further includes a second horizontal support beam 174 that selectively secures the left vertical support beam 58 relative to the right vertical support beam 118 via a second slot 176 that is equipped with a second slot break 178. The second horizontal support beam 174 is positioned forward of the central horizontal support beam 162. The second slot 176 accommodates a second left peg 180, which is rigidly fixed to the left vertical support beam 58, and accommodates a second right peg 182, which is rigidly fixed to the right vertical support beam 118. The second slot break 178 is responsive to control signals from the controller 74. After an airfoil 12 or 14 establishes a desired configuration, the controller 74 issues control signals to reapply the airfoil breaks 72, 132, 168, 178, 188. Similarly, to configure the airfoils 12, 14, the airfoil breaks 72, 132, 168, 178, 188 are initially released as needed.

A third horizontal support beam 184, which is shown for illustrative purposes, is positioned aft of the central horizontal support beam 162. The third horizontal support beam 184 is similar to the second horizontal support beam 174 and includes a corresponding third slot 186 and third break 188 that accommodate third left and right pegs 190, 192.

The various horizontal support beams 162, 174, 184 may be quipped with actuators (not shown) that selectively move the vertical support beams 58, 118 to facilitate airfoil morphing operations in response to control signals from the controller 74. Such actuators could be used in addition to or instead of the actuators 100.

In operation, the controller 74 receives input from sensors 106, control levers and/or buttons 104, or radio control input from the receiver 102 and generates corresponding airfoil control signals in response thereto. The airfoil control signals include actuator control signals to control the various actuators 100, 160 and break control signals to control the various track breaks 72, 132 and support beam breaks 178, 168, 188. Exact details of algorithms running on the controller 74 are application-specific and may be readily implemented by those skilled in the art without undue experimentation.

A pilot may activate certain levers or buttons 104 to adjust the airfoils 12, 14 for desired flight characteristics. For example, a pilot may adjust a lever that generates a corresponding signal to the controller 74 to decrease airfoil sweepback angle. The controller 74 then forwards control signals to the breaks 72, 132, 178, 168, 188 to selectively release the breaks. The controller 74 also forwards actuator control signals to the actuators 100, 160, causing the actuators 100, 160 to shorten, thereby pulling on the corresponding ribs and spars, which pivot about their respective pivot connectors. This causes the first pivot connectors 68, 128 to move toward the fixed second pivot connectors 78, 138 in the support tracks 70, 130.

Similarly, the third pivot connectors 84, 144 move toward the fixed second pivot connectors 78, 138. This action causes the root chords of the airfoils 12, 14 to shorten as the sweepback angles of the airfoils 12, 14 decrease. Simultaneously, the vertical support beams 58, 118 move closer together as associated pegs 180, 182, 170, 172, 190, 192 slide inward toward the longitudinal axis 134 in the horizontal tracks 164, 176, 186 of the horizontal support beams 162, 174, 184. When the desired configuration is achieved, the breaks 72, 132, 178, 168, 188 are reapplied, thereby locking and securing the configuration.

Similarly, to increase airfoil sweepback angles, the breaks 72, 132, 178, 168, 188 are released and the actuators 100, 160 lengthen in response to control signals from the controller 74. This action causes the airfoil chord lengths to expand as the sweepback angles increase and the airfoil areas change accordingly. In this operation, the vertical support beams 58, 118 move apart and away from the longitudinal axis 34. The flexible skin 20 covering the airfoils 12, 14 accommodates various airfoil shape changes. The flexible skin 20 may be replaced with a telescoping or sliding skin or other transformable airfoil surface without departing from the scope of the present invention.

In the present embodiment, the vertical support tracks 70, 130 are specially equipped slots 70, 130. The slots 70, 130 are sufficiently durable to withstand stresses associated with the desired application. The slots 70, 130 may be fitted with special components, such as wheels, bearings, actuators (not shown), and breaks 72, 132. Actuators fitted within the slots 70, 130 may be employed in addition to or instead of the actuators 100, 160 to facilitate airfoil transformations. The breaks 72, 132 may be selectively applied to the slots in response to signals from the controller 74 to help secure the airfoils 12, 14 in a desired configuration. To actuate the airfoils 12, 14, the controller 74 issues a break-release signal to the breaks 72, 132, which enables the actuators 100, 160 to transform the airfoils 12, 14.

In the present embodiment, the central second pivot connectors 78, 138 in the support tracks 70, 130 remain stationary. Alternatively, by selectively employing locks or breaks 72, 132, 178, 168, 188 at the various pivot connectors 72, 78, 84 and 120, 122, 124 within the left support track 70 and the right support track 130, respectively, different pivot connectors other than the central second connectors 62, 122 may remain stationary, while the remaining connectors are allowed to move to facilitate airfoil morphing operations.

One of the support rods 58, 118 may slide beneath the other to maximize allowable changes in airfoil span-wise geometries including airfoil sweep angle, wingspan, and aspect ratio. For the purposes of the present discussion, the term geometries refers to any geometric characteristics, including but not limited to sweep angle, wingspan, and chord length. The term platform geometries refers to geometric characteristics that involve horizontal fluid foil dimensions, including airfoil span, sweep angle, and chord length. Horizontal fluid foil dimensions are those dimensions that define the shape of the airfoil as viewed along a line of sight that is approximately perpendicular to a plane or imaginary surface extending between a leading edge and a trailing edge of an airfoil. For example, horizontal fluid foil dimensions are those geometric characteristics or parameters that define the shape of the airfoils 12, 14 as viewed from above (or below) as in FIG. 3. Vertical fluid foil dimensions include those affecting wing camber.

In an alternative embodiment (not shown), the airfoils 12, 14 are secured via the central horizontal support beam 162 and the vertical support tracks 70, 130 alone. In the alternative implementation, the vertical support rods 58, 118 and portions of the spars and ribs extending into the fuselage 22 beyond the vertical support tracks 70, 130 may be omitted. This embodiment is particularly suited to applications wherein maximum morphing range is desired and in light aircraft and drone applications that do not require additional internal support structures.

The airfoils 12, 14 may be independently controlled to facilitate certain flight maneuvers, such as turning, as discussed more fully below. In the present specific embodiment, the airfoils 12, 14 may be wirelessly controlled from a separate ground, air, or space station via the receiver 102. Similarly, the airfoils 12, 14 may be automatically controlled in response to input from the sensors 106.

Those skilled in the art will appreciate that the electrical fly-by-wire controls implemented via the controller 74 may be replaced with mechanical controls, such as direct mechanic couplings between the control levers 104 and the airfoils 12, 14, without departing from the scope of the present invention. Furthermore, the controllable airfoils 12, 14 and associated system 50 have widely varying applications. For example, the airfoils 12, 14 may be implemented as tail fins on a guided missile, such as a cruise missile, to improve controllability of the missile. The airfoils 12, 14 may be folded back to the maximum sweep angle to facilitate storage and transport. Additional applications include boat rudders, sailboat sails, household fan blades, stirring machines or mixers, hydrofoils, such as swim fins, and so on.

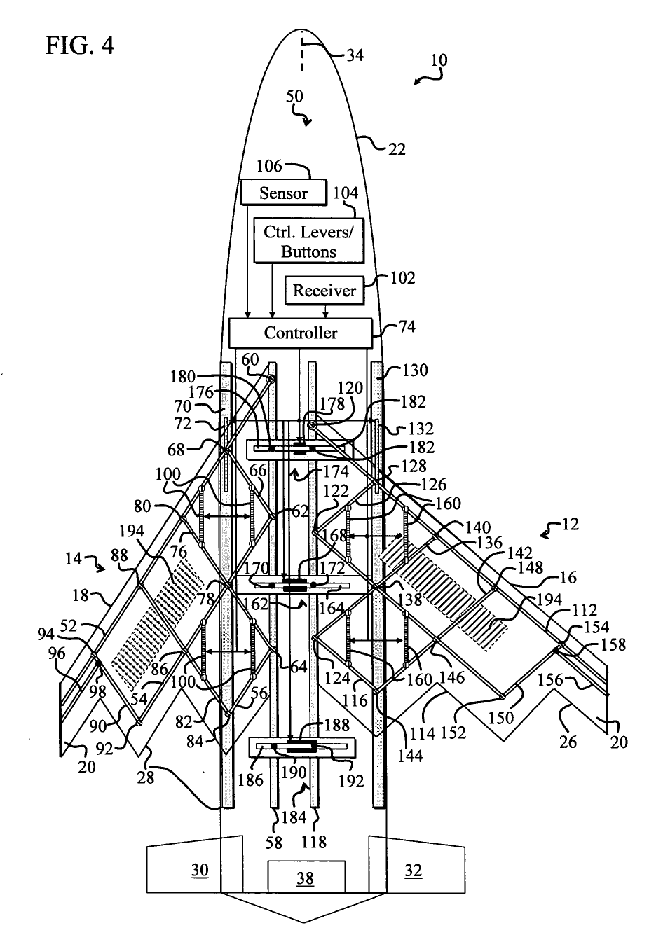

FIG. 4 is a top schematic view of the aircraft 10 of FIG. 1 illustrating an exemplary airfoil configuration for implementing a right turn with a left roll, which could be employed as an evasive dog-fighting maneuver. The left airfoil 14 remains in the 60° swept-back configuration of FIG. 3, while the right airfoil 12 is morphed into a 45° swept-back configuration. The root chord of the right airfoil 12 is reduced from approximately 10.4 units to 8.5 units; the sweep angle is reduced from approximately 60° to 45°; the airfoil aspect ratio is increased from approximately 1.7 to 3.0; and the airfoil area is increased from approximately 50 square units to approximately 58 square units. Accordingly, the right airfoil 12 will produce more lift, causing the aircraft to roll left. The increased drag caused by the expanded area of the right airfoil 12 will promote right yaw right as the aircraft 10 rolls left.

The left vertical support beam 58 and the right vertical support beam 118 may be weighted. Accordingly, when the right airfoil 12 is moved into the 45° swept-back configuration, the right vertical support beam 118 translates left, thereby strategically shifting the center of gravity of the aircraft 10 to the left to further facilitate the left roll or bank.

Furthermore, the centers of pressures of the airfoils 12, 14 may be selectively adjusted by adjusting the shapes of the airfoils 12, 14 to facilitate certain flight maneuvers. For example, the aircraft 10 may be designed so that sweeping the wings 12, 14 back causes the aircraft to pitch downward as the center of pressure of the wings moves aft.

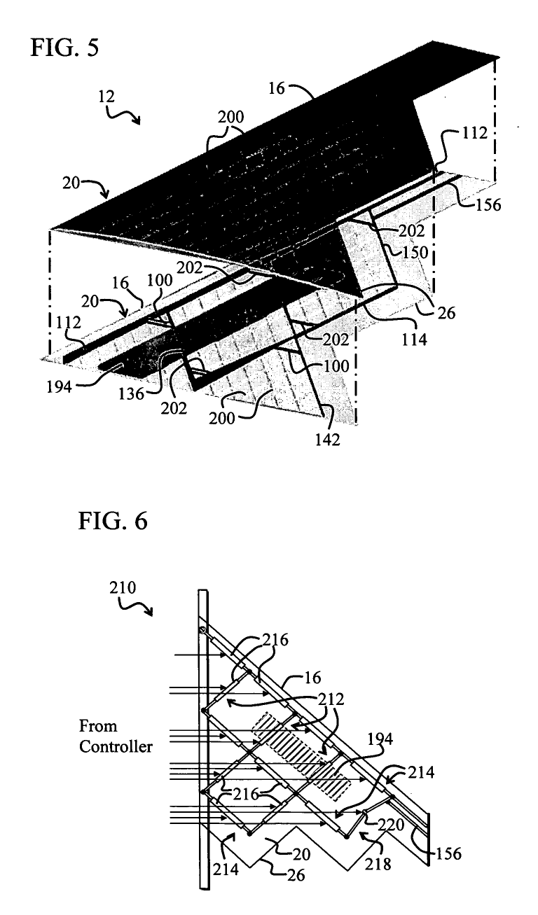

FIG. 5 is a more detailed exploded view of the right airfoil 12 of FIG. 3. The right airfoil 12 includes a flexible skin 20, which may be a telescoping or elastomeric skin or another suitable deformable covering. In the present embodiment, the spars 112, 114, 156 and ribs 136, 142, 150 form an adjustable frame that is sandwiched by the flexible skin 20, which is reinforced with crisscrossed stiffening rods 200. The bellows structures 194, which are partially flattened, allow airfoil frame morphing, but resist airfoil twisting, also called torsion. Additional actuators 202 are shown for illustrative purposes.

In the present embodiment, the flexible skin 20 is chosen to accommodate shear deformation and resist or partially resist biaxial or twisting deformation. The shear deformation (transformation) of the airfoil 14 may minimize energy required to flex the skin 20, thereby reducing requisite sizes, strengths, and associated costs of the actuators 100, 202.

The actuators 100, 202 are chosen so that if they fail, they may telescope relatively free of resistance. Accordingly, if one of the actuators 100, 202 fail, the airfoil 12 will not be frozen or locked in to position. Such actuators are well known and commercially available.

FIG. 6 is a top schematic view of an alternative embodiment of an adjustable airfoil 210 that incorporates telescoping ribs 212 and telescoping spars 214, which are fitted with telescoping actuators 216 that are responsive to control signals from the controller 74 of FIGS. 3 and 4. An additional folding rib 218 is shown for illustrative purposes, and may be driven by a folding motor 220 that is also responsive to control signals from the controller 74 of FIGS. 3 and 4. In the present embodiment, the ribs 212 and spars 214 are rigidly interconnected. However, the ribs 212 and spars 214 may be pivotally interconnected without departing from the scope of the present invention.

By incorporating telescoping spars 214 and ribs 212, various airfoil properties may be independently controlled. For example, airfoil sweepback angle may be controlled independently of airfoil chord or other parameters. Furthermore, the airfoil 210 enables additional length changes in the leading edge 16 and not just sweep angle changes. Such changes may be implemented by selectively telescoping the spars 214.

One or more of the telescoping actuators 216 may be omitted or repositioned without departing from the scope of the present invention. Furthermore, telescoping ribs 212 and spars 214 and folding spars (not shown) and/or ribs 218 may replace certain corresponding pivoting spars and ribs of the airfoils 12, 14 of FIGS. 2 and 3 to meet the needs of a given application.

Thus, the present invention has been described herein with reference to a particular embodiment for a particular application. Those having ordinary skill in the art and access to the present teachings will recognize additional modifications, applications, and embodiments within the scope thereof It is therefore intended by the appended claims to cover any and all such applications, modifications and embodiments within the scope of the present invention.

Accordingly,

What is claimed is:

1. An adjustable fluid foil comprising:
a frame having one or more adjustable spars connected to one or more adjustable ribs and
a deformable surface substantially covering said frame or a portion thereof.

2. The fluid foil of claim 1 wherein said deformable surface is sufficient to enable changes in one or more horizontal or span-wise geometric characteristics of said fluid foil in response to adjusting of said frame, and wherein said one or more adjustable spars and said one or more adjustable ribs are substantially coplanar, 5 sharing a plane that is approximately parallel to said deformable surface.

3. The fluid foil of claim 2 wherein said one or more adjustable spars and said one or more adjustable ribs include means for adjusting position and/or means for adjusting size of one or more of said one or more adjustable ribs and/or of said one or more adjustable spars.

4. The fluid foil of claim 3 wherein said one or more adjustable spars and said one or more adjustable ribs are folding or telescoping.

5. The fluid foil of claim 3 wherein said one or more adjustable spars and said one or more adjustable ribs are pivotally interconnected.

6. The fluid foil of claim 3 wherein said one or more adjustable ribs are connected to said one or more adjustable spars so that actuation of a first spar changes a sweep angle of said fluid foil and simultaneously adjusts a chord of said fluid foil.

7. The fluid foil of claim 1 wherein said one or more adjustable spars include a first spar mounted at a first section to a fuselage.

8. The fluid foil of claim 7 wherein said first section of said first spar is secured within a track along which said first section may slide and in which said first section may pivot, said track mounted on or in said fuselage.

9. The fluid foil of claim 8 wherein said first spar is positioned to provide support for a leading-edge of said fluid foil, and wherein an angle formed by said first spar and said fuselage determines a sweep angle of said fluid foil.

10. The fluid foil of claim 9 further including an actuator sufficient to adjust said sweep angle via actuation of said first spar.

11. The fluid foil of claim 10 wherein said one or more adjustable ribs include a first rib having a first section mounted to said fuselage and a second section mounted to said first spar.

12. The fluid foil of claim 11 wherein said first section of said first spar is mounted to said fuselage at a first pivot connector that may slide within said track.

13. The fluid foil of claim 12 wherein said first section of said first rib is rigidly mounted in said track so that said first section does not slide within said track.

14. The fluid foil of claim 13 wherein said first section of said first rib is connected to said fuselage at a pivot connector that is rigidly mounted in said first track.

15. The fluid foil of claim 13 wherein said first rib accommodates a telescoping actuator.

16. The fluid foil of claim 13 wherein said fluid foil is a first airfoil, and further including a second airfoil that is similar to said first airfoil and that is mounted on an opposite side of said fuselage, said first airfoil and said second airfoil forming wings of an aircraft.

17. The fluid foil of claim 16 wherein said first section of said first rib is secured via a support beam that extends from said first section of said first rib to a first section of a corresponding rib on said second airfoil.

18. The fluid foil of claim 17 further including first means for independently adjusting said first airfoil and said second airfoil by selectively adjusting angles between said one or more adjustable spars and said one or more adjustable ribs.

19. The fluid foil of claim 18 wherein said first means includes second means for selectively shifting a center of gravity of said aircraft to facilitate maneuvering said aircraft in response to adjusting said first airfoil and/or said second airfoil.

20. An adjustable fluid foil comprising:
first means for selectively expanding or contracting a cord of said fluid foil and
second means for automatically sweeping back or sweeping forward said fluid in response to actuation of said first means.

21. The fluid foil of claim 20 further including third means for receiving input and providing a control signal in response thereto, said first means responsive to said control signal.

22. The fluid foil of claim 21 further including a deformable skin disposed over said transformable fluid foil so that an area and/or a span of said fluid foil selectively changes in response to actuation of said first and second means.

23. The fluid foil of claim 22 wherein said first means is mechanically connected to said second means so that actuation of said first means causes actuation of said second means and deformation of said deformable skin.

24. The fluid foil of claim 23 further including a fuselage attached to said fluid foil at a base of said fluid foil.

25. The fluid foil of claim 24 wherein said first means includes a first track mounted on or within said fuselage, said first track accommodating said base of said fluid foil.

26. The fluid foil of claim 25 wherein said second means includes one or more spars and one or more ribs that form a frame of said fluid foil.

27. The fluid foil of claim 26 wherein said one or more spars include a first leading-edge spar and a first rib, and wherein said first leading edge spar and said first rib are mechanically linked so that actuation of said spar causes actuation of said rib and vice versa.

28. The fluid foil of claim 27 wherein said second means includes a first actuator coupled to said first leading-edge spar and said first rib so that selective actuation of said first actuator causes said leading-edge spar to sweep forward or aft and said chord to expand or contract, respectively.

29. The fluid foil of claim 28 wherein said fluid foil is mounted on said fuselage so that selective actuation of said first actuator causes a base section of said first leading edge spar and a base section of said first rib, which are positioned within said first track, to move with respect to each other within said first track, thereby causing selective expansion or contraction of said chord and selective sweep back or sweep forward of said fluid foil.

30. The fluid foil of claim 29 wherein said first track includes one or more breaks responsive to a control signal output by said third means.

31. The fluid foil of claim 28 wherein said first leading edge spar is pivotally connected to a terminal end of said first rib at a first pivot connector.

32. The fluid foil of claim 31 wherein said first actuator is connected between said first leading edge spar and said first rib so that actuation of said actuator causes pivoting of said rib and spar about said first pivot connector.

33. The fluid foil of claim 32 wherein said third means includes a controller, and wherein said controller is responsive to predetermined input, and wherein and said actuator is responsive to said control signal output from said controller.

34. The fluid foil of claim 27 wherein said first rib is telescopic and incorporates a telescoping actuator, and wherein said first rib is rigidly connected to said spar at a predetermined position along said spar and at or near a terminal end of said first rib.

35. The fluid foil of claim 34 wherein said fluid foil is an airfoil that further includes a bellows structure positioned within said frame to selectively inhibit torsion of said airfoil.

36. The fluid foil of claim 26 wherein said fluid foil is a first transformable wing on an aircraft, said aircraft including a second transformable wing that is independently transformable relative to said first transformable wing in response to control signals from said third means.

37. The fluid foil of claim 36 wherein said first transformable wing and said second transformable wing are mechanically linked via one or more stabilizing beams.

38. An adjustable fluid foil comprising:
first means for selectively changing a sweep angle of said fluid foil and
second means for automatically changing an area and a chord length of said fluid foil in response to activation of said first means.

39. The fluid foil of claim 38 further including third means for automatically adjusting a chord length of said fluid foil in response to actuation of said first means and/or said second means, said third means mechanically linked to said second means and said first means.

40. The fluid foil of claim 39 wherein said second means includes an adjustable skin that substantially covers said fluid foil or a portion thereof.

41. An adjustable fluid foil comprising:
a frame including a first adjustable spar and a first adjustable rib and
a deformable surface covering said frame or a portion thereof, said deformable surface approximately horizontally disposed relative to said frame.

42. The adjustable fluid foil of claim 41 wherein said frame includes plural adjustable ribs and plural adjustable spars pivotally interconnected and arranged so that adjustments of sweep angle of a leading edge of said fluid foil in response to adjustments of said plural adjustable spars and ribs occur independently of adjustments in sweep angle of a trailing edge of said fluid foil.

43. A transformable aircraft comprising:
an aircraft fuselage;
a controller that provides control signals;
a first transformable wing mounted on a first side of said fuselage, said first transformable wing having one or more spars moveably linked to one or more ribs so that actuation of said one or more spars causes actuation of said one or more ribs, said first transformable wing including a deformable skin;
a second transformable wing similar to said first transformable wing but mounted on a second side of said fuselage;
one or more actuators connected to said one or more spars and to said one or more ribs of said first transformable wing and said second transformable wing, said actuators sufficient to selectively adjust span, chord, area, sweep, and/or aspect ratio of said first transformable wing independently of said second transformable wing by selectively actuating said one or more spars and said one or more ribs of said first transformable wing and said second transformable wing in response to said control signals.

44. The morphing aircraft of claim 43 further including a rigid mechanical link between said first transformable wing and said second transformable wing, said mechanical link allowing independent morphing of said first wing and said second wing.

45. The morphing aircraft of claim 43 further including first means for independently morphing said first transformable wing and said second transformable wing to facilitate maneuvering said aircraft.

46. The morphing aircraft of claim 45 wherein said first means includes means for selectively adjusting the center of gravity of said aircraft in response to independent morphing of said first transformable wing and said second transformable wing.
